(19) United States
(12) Patent Application Publication
(10) Pub. No.: US 2016/0069209 A1
(43) Pub. Date: Mar. 10, 2016

(54) DEVICE FOR WASHING A TURBOMACHINE AIR INTAKE CASING

(71) Applicant: TURBOMECA, Bordes (FR)

(72) Inventors: Julien GIRARDOT, Angais (FR); Pierre CHABANNE, Idron (FR); Sylvain Jacque, Marie GOURDANT, Gelos (FR); Lionel SCUILLER, Billere (FR)

(73) Assignee: TURBOMECA, Bordes (FR)

(21) Appl. No.: 14/787,958

(22) PCT Filed: Apr. 23, 2014
(86) PCT No.: PCT/FR14/50987

§ 371 Date: Oct. 29, 2015

(30) Foreign Application Priority Data
Apr. 30, 2013 (FR) 1353984

(51) Int. Cl. F01D 25/00; F02C 7/30

(52) U.S. Cl. CPC F01D 25/002; F02C 7/30

(57) ABSTRACT

A turbomachine air intake casing including an inner annular wall and an outer annular wall defining an air passage and at least two cleaning agent injection nozzles, wherein a first nozzle is directed towards the outer wall while a second nozzle is directed towards the inner wall.

### FIELD OF THE INVENTION

The invention relates to an air intake casing for a turbomachine, and more particularly to an air intake casing having nozzles for injecting a cleaning agent. The invention also provides a turbomachine including such an air intake casing.

The term “turbomachine” covers all gas turbine devices producing motive power, including in particular gas turbine reaction engine that provide thrust for providing propulsion by reaction to ejecting hot gas at high speed, and turboshaft engines where the motive power is delivered by rotating a drive shaft. By way of example, turboshaft engines are used as engines for helicopters, ships, trains, or indeed as industrial power plants. Turboprops (a turboshaft engine driving a propeller) also constitute turboshaft engines that are used as aeroengines.

### STATE OF THE PRIOR ART

A turbomachine air intake casing is known that comprises an inner annular wall and an outer annular wall defining an air passage, together with at least two nozzles for injecting a cleaning agent. Nevertheless, under certain conditions, the cleaning obtained by using those nozzles is not satisfactory and it becomes necessary to perform manual cleaning. Such manual action is expensive and difficult.

### SUMMARY OF THE INVENTION

An object of the invention is to remedy the above-mentioned drawbacks at least substantially.

The invention achieves this object by proposing a turbomachine air intake casing having an inner annular wall and an outer annular wall defining an air passage, and at least two cleaning agent injection nozzles (in said casing), wherein a (i.e. at least one) first nozzle is directed towards the outer wall while a (i.e. at least one) second nozzle is directed towards the inner wall.

It can be understood that the turbomachine air intake casing (referred to below as “the casing”) has one or more first nozzles, one or more second nozzles, and possibly one or more other nozzles, e.g. one or more third, fourth, etc. nozzles.

Below, and unless specified to the contrary, the term “the first nozzle” designates the sole first nozzle if there is only one or all of the first nozzles if there are more than one. Likewise, the term “the second nozzle” designates the sole second nozzle if there is only one or all of the second nozzles if there are more than one. The same applies to the third, fourth, etc. nozzles.

Naturally, the first nozzle is distinct from the second nozzle. More generally, the first nozzle and the second nozzle are distinct from the third, fourth, etc. nozzles.

The first nozzle is in the inner annular wall while the second nozzle is in the outer annular wall, or vice versa. In a variant, the first and second nozzles are both in the same wall, i.e. the inner annular wall or the outer annular wall.

The nozzles may be formed directly in the casing, e.g. in the thickness of the inner or outer annular wall. For example, the nozzles may comprise respective holes passing through said wall that can be made by conventional drilling or by electroerosion. In a variant, the nozzles are formed by parts that are distinct from the casing, but that are secured thereto. Naturally, certain nozzles may be formed directly in the casing while other nozzles are formed by parts that are distinct from the casing.

It should also be understood that the inner annular wall, also referred to as the “inner wall”, is the air duct defining annular wall of the air intake casing that is arranged radially closer to the axis of the casing, at least over an axial fraction of the casing. Conversely, the outer annular wall, also referred to as the “outer wall”, is the air duct defining annular wall of the casing defining the air passage that is radially further from the axis of the casing, at least over an axial friction of the casing.

In general, the radial direction is a direction perpendicular to the axis (or axial direction) of the casing. The azimuth direction corresponds to a direction describing a ring around the axial direction. The axial, radial, and azimuth directions correspond respectively to the directions defined by the height, the radius, and the angle in a cylindrical coordinate system.

The first nozzle is directed towards the outer wall, which wall is the more sensitive from an aerodynamic point of view, while the second nozzle is directed towards the inner wall. This ensures that both of the main air duct defining walls of the casing receive the cleaning agent directly in order to clean them. Furthermore, the cleaning agent is preferably injected under pressure in the range approximately 3 bars to 10 bars (i.e. 0.3 megapascals (MPa) to 1.0 MPa). Thus, the cleaning agent that strikes the annular walls is diffused after impact into the air feeding the turbomachine. Consequently, after impacting against the walls of the casing, the cleaning agent is diffused within the entire casing, and then introduced downstream into the turbomachine. Thus, all of the zones of the air intake casing together with the walls defining the air flow path through the turbomachine, including in zones that are difficult to access, receive the cleaning agent and are thus cleaned, and this is done in uniform manner. Such a uniform distribution of cleaning agent serves in particular to improve the effectiveness of each cleaning operation, and thus to reduce the consumption of cleaning agent.

Naturally, the nozzles may be of the concentrated jet type or of the diffuse jet or atomizer type. This makes it possible to adapt the jet to the shape of the impact zone on the wall and also to adapt the impact power of the jet against the wall. In one variant, the first nozzle and the second nozzle are nozzles of the concentrated jet type. In another variant, the first nozzle and the second nozzle are nozzles of the concentrated jet type, while a third nozzle is of the diffuse jet type.

When the air intake casing presents a plurality of first nozzles, the first nozzles are advantageously arranged in a common axial plane (i.e. a plane perpendicular to the axial direction of the air intake casing). Likewise, when the air intake casing presents a plurality of second nozzles, the second nozzles are advantageously arranged in a common axial plane (distinct from the axial plane of the first nozzles). This ensures that all of the first nozzles and all of the second nozzles have respectively the same effect on the walls impacted by the jets they produce.

In general, in the meaning of the invention, the position of a nozzle within the casing is given by the position of the geometrical center of the outlet orifice of said nozzle. The orifice of each of the nozzles presents a general shape that is circular, elliptical, or oblong, however it could naturally present any other shape. Naturally, certain nozzles may present an orifice of one general shape while other nozzles present an orifice of a general shape that is different (in terms of size and/or geometry).

When the air intake casing presents a plurality of first nozzles, the first nozzles are advantageously regularly distributed in azimuth. Likewise, when the air intake casing presents a plurality of second nozzles, the second nozzles are advantageously regularly distributed in azimuth. A regular distribution in azimuth serves in particular to improve the uniformity of cleaning.

In one variant, there are as many first nozzles as second nozzles. In another variant, in order to obtain as uniform as possible a distribution of cleaning agent on the impact surface, the numbers of first and second nozzles are prorata the surface areas of the impact walls. In other words, the number of nozzles per unit area of an impact wall (or nozzle density) is the same for the first nozzles and for the second nozzles. In this variant, the total number of first nozzles can thus be different from the total number of second nozzles, if the areas of the impact walls are different. Advantageously, the air intake casing has at least one set of nozzles comprising a first nozzle directed towards the outer wall and a second nozzle directed towards the inner wall, the first nozzle and the second nozzle in the set of nozzles being arranged in a common radial half-plane of the air intake casing.

A radial half-plane is a half-plane extending from the axis of the air intake casing in a direction that is radial (i.e. parallel to the axis of the air intake casing). Thus, a radial plane contains two radial half-planes. It should be recalled that a radial plane is a plane parallel to the axis of the casing and containing the axis of the casing.

It can be understood that each set of nozzles comprises a first nozzle and a second nozzle and possibly also a third and/or fourth, etc. nozzle. When the set of nozzles has one or more nozzles other than the first and second nozzles, the other nozzle(s) may also be arranged in the same radial half-plane as the radial half-plane of the first and second nozzles (i.e. all of the nozzles are in a common radial half-plane), or only some of these other nozzles might be arranged in that common radial half-plane, or indeed none of the other nozzles need be arranged in that common radial half-plane.

Such a distribution of a first nozzle and a second nozzle serves to optimize the space occupied by the circuit for feeding the nozzles with cleaning agent.

Advantageously, the casing has a plurality of first nozzles regularly distributed in azimuth within said casing and a plurality of second nozzles regularly distributed in azimuth within said casing.

Advantageously, the first nozzles are arranged in a common axial plane. Advantageously, the second nozzles are arranged in a common axial plane. Advantageously, the axial plane of the first nozzles is distinct from the axial plane of the second nozzles.

These various configurations, taken singly or in combination serve to optimize the uniformity with which cleaning agent is sprayed, while presenting a structure that is simple.

Advantageously, the air intake casing has a plurality of sets of nozzles that are regularly distributed in azimuth within said casing.

In the same manner as above, it can be understood that each set comprises a first nozzle, a second nozzle, and possibly one or more other nozzles.

The various sets of nozzles are regularly spaced apart in the azimuth direction of the casing. Thus, when the casing presents two sets of nozzles, these two sets are substantially diametrically opposite, when the casing presents three sets of nozzles, the sets are spaced apart substantially at 120° (one hundred and twenty degrees of angle) from one another, etc. Such a distribution serves to improve the uniformity of cleaning.

In a variant, there are as many first nozzles as there are second nozzles, the first and second nozzles being regularly distributed in azimuth, the first and second nozzles being arranged in pairs (each pair comprising a single first nozzle and a single second nozzle) in a common radial half-plane, all of the first nozzles being arranged in a common first axial plane while all of the second nozzles are arranged in a common second axial plane distinct from the first axial plane.

Such a configuration presents minimal complexity, while enabling optimum cleaning to be obtained.

Advantageously, the casing has first and second nozzles only (i.e. only one or more first nozzles and one or more second nozzles).

The inventors have observed that such a configuration provides a good balance between the number of nozzles, which needs to be minimized in order to ensure that the casing is simple in structure, and the effectiveness of cleaning, which on the contrary requires as many nozzles as possible. This serves to optimize the effectiveness of the cleaning agent while limiting the number of nozzles to the strict minimum necessary.

Advantageously, the first nozzle and the second nozzle are directed downstream, where upstream and downstream are considered relative to the upstream to downstream flow direction of the stream through the air intake casing.

The downstream direction of the first and second nozzles also makes it possible to clean elements that are arranged downstream from the casing within the turbomachine, such as for example an axial variable pre-rotation grid (also known as inlet guide vanes (IGV)), and/or a compressor impeller (or wheel).

Advantageously, the first nozzle is arranged upstream from the second nozzle, with upstream and downstream being considered relative to the upstream to downstream flow direction of the stream through the air intake casing.

This arrangement serves in particular to avoid interference between the jet from the first nozzle and the jet from the second nozzle.

Advantageously, the air intake casing forms a radial air intake casing.

A radial air intake casing is a casing in which the air admission orifice faces substantially radially while the air outlet orifice is directed substantially axially.

This type of casing is used for example in helicopter turboshaft engines.

In a variant, the first nozzle and the second nozzle are arranged on the inner wall. This variant is particularly well adapted to radial air intake casings.

Advantageously, the air intake casing has a cleaning agent feed circuit for feeding the nozzles with cleaning agent.

Such a feed circuit makes it easy to feed the nozzles during cleaning operations. Thus, when it is desired to clean the casing and/or the walls of the air flow path downstream from the casing through the turbomachine, a pump is connected directly to the feed circuit and the cleaning agent is injected into the feed circuit using the pump, so that each of the nozzles produces a jet of cleaning agent within the casing. The feed circuit is incorporated within the casing. By way of example, the circuit may be incorporated when fabricating the casing (e.g. by casting, the pipework thus being fabricated in full or in part together with the casing, so as to form a single integral part) and/or by using pipework that is subsequently fitted in full or in part and secured to the casing. In other words, the feed circuit is pre-installed on the casing. Thus, when the casing is installed within a turbomachine, the feed circuit is installed at the same time without any additional operation.

The invention also provides a turbomachine including the air intake casing of the invention.

Advantageously, the turbomachine is a helicopter turboshaft engine. The air intake casing of the invention, and more particularly the radial air intake casing is particularly well adapted to helicopter turboshaft engines.

### BRIEF DESCRIPTION OF THE DRAWINGS

The invention and its advantages can be better understood on reading the following detailed description of the embodiment of the invention given by way of non-limiting example. The description refers to the accompanying figures, in which:

FIG. 1 shows a turbomachine of the invention;

FIG. 2 shows an air intake casing of the FIG. 1 engine, in axial section view;

FIG. 3 shows the air intake casing of the FIG. 1 engine, seen in perspective looking along arrow III of FIG. 2.

### DETAILED DESCRIPTION OF EMBODIMENTS

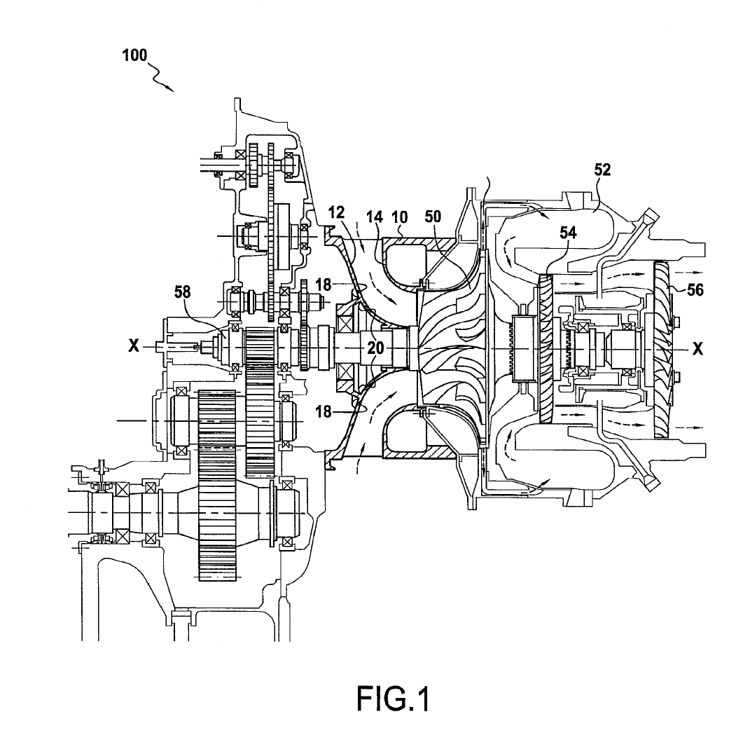

FIG. 1 shows a helicopter turboshaft engine 100 forming a turbomachine of the invention. This engine 100 has an air intake casing 10 of the invention via which air penetrates into the engine 100. This air flows through the engine from upstream to downstream in the direction shown by dashed line arrows. Thus, after penetrating into the engine 100 via the casing 10, the air is compressed by a compressor 50, then heated in the combustion chamber 52, and expanded in the turbines 54 and 56. The turbine 56 rotates the shaft 58 that delivers the motive power needed for propelling the helicopter (not shown). At the outlet from the turbine 56, air is expelled to the outside of the engine 100.

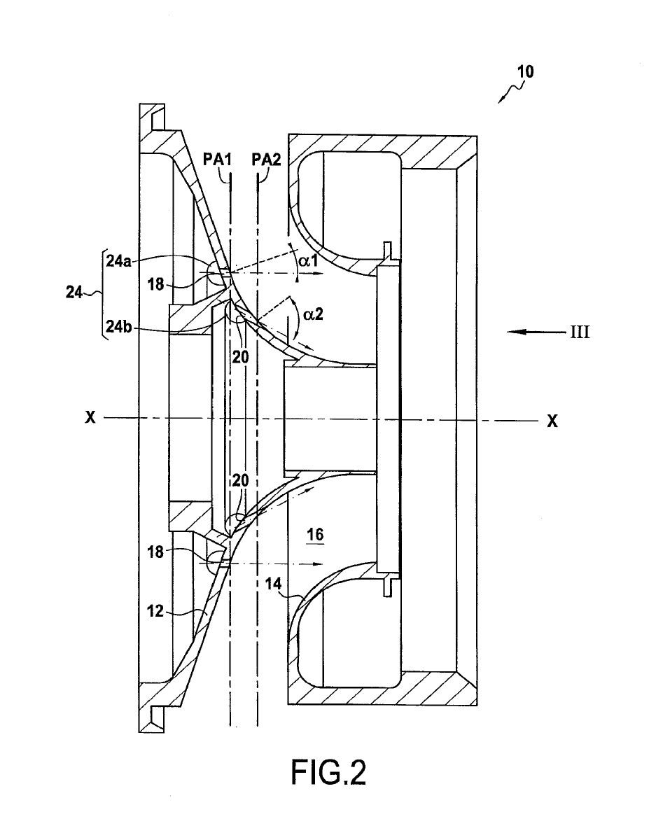

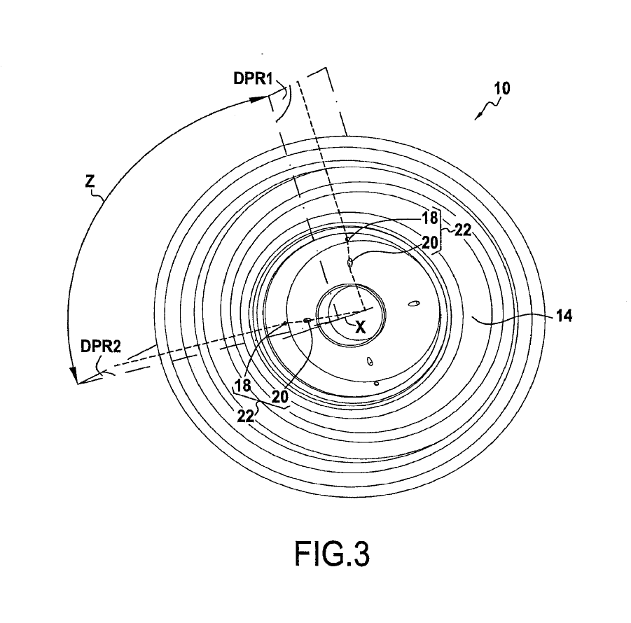

FIGS. 2 and 3 show the air intake casing 10 in greater detail. This air intake casing 10 is a radial air intake casing. The casing 10 extends along an axial direction X and comprises an inner annular wall 12 and an outer annular wall 14. The inner and outer annular walls 12 and 14 are substantially coaxial, and together they define an annular air passage 16. It should be observed that the inner and outer walls are secured to each other by spacers extending radially across the annular passage 16, these spacers not being shown, for greater clarity. Naturally, depending on the shape of the spacers, it can be considered that the air passage comprises one or more passages forming one or more ring sectors.

The inner wall 12 has first nozzles 18 directed towards the outer wall 14, and second nozzles 20 directed towards the inner wall 12. The chain-dotted line arrows of FIG. 2 show the directions of the nozzles and the zones impacted by the jets produced by the nozzles. The first nozzles 18 are distinct from the second nozzles 20. In this example, the casing 10 has four first nozzles 18 and four second nozzles 20. Naturally, in a variant, the casing 10 could have one, two, three, or more than four first and/or second nozzles.

The first nozzles 18 are arranged in a single first axial plane PA1, while the second nozzles 20 are arranged in a single second axial plane PA2 that is distinct from the first axial plane PA1 (cf. FIG. 2).

The first nozzles 18 are regularly spaced apart in the azimuth direction Z. Thus, there is an angle of 90° between adjacent first nozzles 18. Likewise, the second nozzles 20 are regularly spaced apart in the azimuth direction Z. An angle of 90° thus lies between adjacent second nozzles 18.

Each first nozzle 18 lies in the same azimuth position as a second nozzle 20. Thus, in this example, the casing 10 has four sets 22, each comprising a single first nozzle 18 and a second nozzle 20, with said first nozzle 18 and said second nozzle 20 both lying in the same radial half-plane that extends radially from the axis X of the casing 10. Radial half-planes DPR1 and DPR2 are shown in FIG. 3. The first and second nozzles 18 and 20 in a first set 22 lie in a first radial half-plane DPR1. Likewise, the first and second nozzles 18 and 20 of a second set 22 lie in a second radial half-plane DPR2 that is distinct from the first radial half-plane DPR1. The sets 22 of first and second nozzles 18 and 20 are regularly spaced apart in the azimuth direction Z. An angle of 90° thus lies between adjacent sets 22.

All of the first nozzles 18 and also of the second nozzles 20 are directed downstream relative to the casing 10. It should be observed that the flow direction of the stream from upstream to downstream through the casing 10 is shown in dashed-line arrows in FIG. 1.

In this example, each of the first nozzles 18 (or each of the jets that they generate) forms an angle α1 lying in the range 10° to 50° with the normal to the inside wall, this angle α1 being considered in a radial plane. Each of the first nozzles preferably forms an angle α1 of about 20°.

Likewise, in this example, each of the second nozzles 20 (or each of the jets that they generate) forms an angle α2 lying in the range 30° to 80° with the normal to the inner wall, this angle α1 being considered in a radial plane. Preferably, each of the second nozzles forms an angle α2 of about 70°.

Naturally, in a variant, each of the nozzles (or each of the jets that they generate) could also form an angle relative to the radial plane in which the orifices of the nozzles lie so as to form a jet that swirls around the axial direction X.

The casing 10 also incorporates a circuit 24 for feeding the nozzles 18 and 20 with a cleaning agent. The circuit 24 has first annular pipe 24a feeding the first nozzles 18 and second annular pipe 24b feeding the second nozzles 20 (cf. FIG. 2). In this example, the pipes 24a and 24b are formed by casting during fabrication/casting of the casing. The first and second pipes 24a and 24b are independent so as to be able to inject a cleaning agent into the casing 10 at a first pressure via the first nozzles 18 and at a second pressure different from the first pressure via the second nozzles 20. Each of the first and second pipes 24a and 24b has a coupling (not shown) for coupling it to a cleaning agent feed. Naturally, in a variant, a single common pipe could feed the first and second nozzles, or indeed the pipes 24a and 24b could be connected together.

Although the present invention is described with reference to specific embodiments, it is clear that modifications and changes could be made thereto without going beyond the general ambit of the invention as defined by the claims. In particular, individual characteristics of the various embodiments or variants shown and/or mentioned may be combined in additional embodiments. Consequently, the description and the drawings should be considered as being illustrative rather than restrictive.

1. A turbomachine air intake casing comprising an inner annular wall and an outer annular wall defining an air passage and at least two cleaning agent injection nozzles, wherein a first nozzle is directed towards the outer wall while a second nozzle is directed towards the inner wall, the first nozzle and the second nozzle being arranged in the inner wall.

2. An air intake casing according to claim 1, including at least one set of nozzles comprising a first nozzle directed towards the outer wall and a second nozzle directed towards the inner wall, the first nozzle and the second nozzle of the set of nozzles being arranged in a common radial half-plane.

3. An air intake casing according to claim 1, having a plurality of first nozzles regularly distributed in azimuth within said casing and a plurality of second nozzles regularly distributed in azimuth within said casing.

4. An air intake casing according to claim 1, wherein the first nozzle and the second nozzle are directed downstream, where upstream and downstream are considered relative to the upstream to downstream flow direction of the stream through the air intake casing.

5. An air intake casing according to claim 1, wherein the first nozzle is arranged upstream from the second nozzle, upstream and downstream being considered relative to the upstream to downstream flow direction of the stream through the air intake casing.

6. An air intake casing according to claim 1, forming a radial air intake casing.

7. An air intake casing according to claim 1, including a cleaning agent feed circuit for feeding the nozzles with cleaning agent.

8. A turbomachine including an air intake casing according to claim 1.
